(19) United States
(12) Patent Application Publication
(10) Pub. No.: US 2026/0080500 A1
(43) Pub. Date: Mar. 19, 2026

(54) METHOD FOR ACCEPTANCE INSPECTION AUDIT

(71) Applicant: JACKSOFT COMMERCE AUTOMATION LTD., Chiayi City (TW)

(72) Inventor: Hsiu-Feng HUANG, Chiayi City (TW)

(73) Assignee: JACKSOFT COMMERCE AUTOMATION LTD., Chiayi City (TW)

(21) Appl. No.: 19/321,388

(22) Filed: Sep. 8, 2025

(30) Foreign Application Priority Data
Sep. 13, 2024 (TW) 113134824

(51) Int. Cl. G06T 3/40; G06T 3/60; G06T 7/00; G06V 10/74

(52) U.S. Cl. CPC G06T 3/40; G06T 3/60; G06T 7/0002; G06V 10/761

(57) ABSTRACT

A method for acceptance inspection audit is implemented by a computer that stores original image data sets. Each original image data set corresponds to an object image, and an image height-width data set of the object image that corresponds to one of image height-width categories. The method includes steps of: A) based on the image height-width data sets, counting a number of occurrences of each of the image height-width categories; B) obtaining, as a target image height-width category, one of the image height-width categories that has a greatest number of occurrences; C) for each original image data set in a group of to-be-inspected data sets, adjusting the object image based on the target image height-width category, thereby obtaining an adjusted-original image data set; and D) obtaining at least one image inspection result based at least on the adjusted-original image data sets thus obtained respectively for the original image data sets.

### CROSS-REFERENCE TO RELATED APPLICATION

This application claims priority to Taiwanese Invention Patent Application No. 113134824, filed on Sep. 13, 2024, the entire disclosure of which is incorporated by reference herein.

### FIELD

The disclosure relates to a method for acceptance inspection audit, and more particularly to a method for acceptance inspection audit using image processing.

### BACKGROUND

Traditionally, procurement acceptance audits are conducted by randomly sampling a few procurement acceptance transaction documents and manually inspecting the procurement acceptance transaction documents, or by manually checking specific procurement acceptance transaction documents based on received information. However, manual inspection in procurement audits is slow and incapable of verifying all procurement acceptance transaction documents. In particular, with respect to images contained in the procurement acceptance transaction documents, it is even more difficult to detect whether abnormalities exist.

### SUMMARY

Therefore, an object of the disclosure is to provide a method for acceptance inspection audit that can alleviate at least one of the drawbacks of the prior art.

According to an aspect of the disclosure, the method is implemented by a computer. The computer stores a plurality of to-be-inspected (TBI) data sets. Each of the TBI data sets includes a respective one of a plurality of original image data sets. Each of the original image data sets corresponds to an object image of a respective one of a plurality of TBI objects, and an image height-width (HW) data set of the object image that corresponds to one of a plurality of image HW categories. The method includes steps of: A) based on the image HW data sets that correspond to the original image data sets, counting a number of occurrences of each of the image HW categories; B) obtaining, as a target image HW category, one of the image HW categories that has a greatest number of occurrences; C) for each of the original image data sets in a group of the TBI data sets, adjusting a height and a width of the object image that corresponds to the original image data set based on the target image HW category, thereby obtaining an adjusted-original image data set that corresponds to an adjusted object image, which is the object image that has been adjusted; and D) obtaining at least one image inspection result based at least on the adjusted-original image data sets that were obtained respectively for the original image data sets.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a computer for implementing a method for acceptance inspection audit according to an embodiment of the present disclosure.

FIG. 2 is a flow chart illustrating a repetitive image inspection procedure of the method for acceptance inspection audit according to a first embodiment of the present disclosure.

FIG. 3 is a flow chart illustrating an image augmentation procedure according to the first embodiment of the present disclosure.

FIG. 4 is a flow chart illustrating a similar-image identification procedure according to the first embodiment of the present disclosure.

FIG. 5 is a flow chart illustrating a duplicate elimination procedure according to the first embodiment of the present disclosure.

FIG. 6 is a flow chart illustrating a non-similar image inspection procedure of the method for acceptance inspection audit according to a second embodiment of the present disclosure.

FIG. 7 is a flow chart illustrating a non-similar image identification procedure according to the second embodiment of the present disclosure.

FIG. 8 is a flow chart illustrating a standard-original image selection procedure according to the second embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

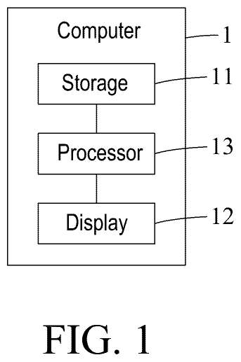

Referring to FIG. 1, a computer 1 for implementing a method for acceptance inspection audit according to an embodiment of the present disclosure includes a storage 11, a display 12, and a processor 13 that is electrically connected to the storage 11 and the display 12.

The storage 11 stores a plurality of to-be-inspected (TBI) data sets, and a plurality of accumulated rotation angles. Each of the TBI data sets includes a respective one of a plurality of original image data sets, and a respective one of a plurality of additional data sets. The additional data sets correspond respectively to a plurality of TBI objects. Each of the original image data sets corresponds to an object image of a respective one of the TBI objects, an image height-width (HW) data set of the object image that corresponds to one of a plurality of image HW categories, and a respective one of the accumulated rotation angles. Each of the accumulated rotation angles has an initial value of zero. Each of the additional data sets includes at least one of a purchaser, a manufacturer code, a manufacturer name, an acceptance date, and an acceptor, although the disclosure is not limited thereto. It should be noted that each of the TBI data sets may be imported from an external device, from recording software of an external device, or from a database, and the disclosure is not limited in this respect.

The computer 1 may be exemplified by a tablet, a notebook computer, a smartphone, or a desktop computer, but the disclosure is not limited in this respect.

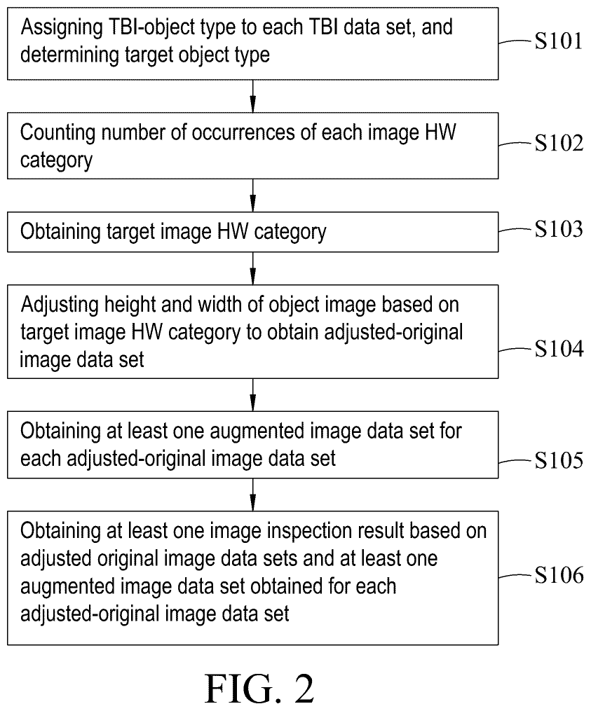

Referring to FIG. 2, the method for acceptance inspection audit according to a first embodiment of the present disclosure is implemented by the computer 1 in FIG. 1. The method includes a repetitive image inspection procedure that includes steps S101 to S106.

In step S101, for each of the TBI data sets, the processor 13 assigns a TBI-object type from among a plurality of TBI-object types to the TBI data set. By assigning each of the TBI data sets with one of the TBI-object types, the processor 13 classifies the TBI objects that correspond to the TBI data sets into the TBI-object types, but the disclosure is not limited in this respect. The processor 13 then selects one of the TBI-object types as a target object type. Those of the TBI data sets assigned with the TBI-object type that matches the target object type serves as target-TBI data sets. In this embodiment, the subsequent steps are performed with respect to the target-TBI data sets, and sometimes the term “target-TBI data sets” may be omitted in the following description for the sake of brevity. For example, the term “original image data sets” in the following description refers to “original image data sets of the target-TBI data sets,” rather than “original image data sets of the plurality of TBI data sets.” In other embodiments, step 101 may be omitted where the processor 13 does not classify the TBI data sets, and the subsequent steps may be performed with respect to all of the TBI data sets.

In step S102, the processor 13 counts a number of occurrences of each of the image HW categories based on the image HW data sets that correspond to the original image data sets. In this embodiment, the number of occurrences of each of the image HW categories is counted based on target-image HW data sets, which are those of the image HW data sets that correspond to those of the original image data sets of the target-TBI data sets. Each of the image HW data sets includes a pixel height number and a pixel width number that are related respectively to a height and a width of the corresponding object image.

In step S103, the processor 13 obtains, as a target image HW category, one of the image HW categories that has a greatest number of occurrences. In this embodiment, said one of the image HW categories that serves as the target image HW category has the greatest number of occurrences in the target-image HW data sets.

In step S104, for each of the original image data sets in a group of TBI data sets, the processor 13 adjusts the height and the width of the object image that corresponds to the original image data set based on the target image HW category, thereby obtaining an adjusted-original image data set that corresponds to an adjusted object image, which is the object image that has been adjusted. In this embodiment, the target-TBI data sets form the group of TBI data sets. That is to say, in this embodiment, for each of the original image data sets in the target-TBI data sets, the processor 13 obtains the adjusted-original image data set by adjusting the height and the width of the object image that corresponds to the original image data set based on the target image HW category. In embodiments where step S101 is omitted, the TBI data sets form the group of TBI data sets. By virtue of the abovementioned arrangement, the processor 13 may obtain the adjusted-original image data set for each of the original image data sets of the group of TBI data sets in a minimum number of times of adjusting the object images that correspond respectively to the original image data sets.

In step S105, for each of the adjusted-original image data sets that were obtained respectively for the original image data sets, the processor 13 obtains at least one augmented image data set based on the adjusted-original image data set. Each of the at least one augmented image data set corresponds to a rotated image that is obtained by rotating the adjusted object image corresponding to the adjusted-original image data set.

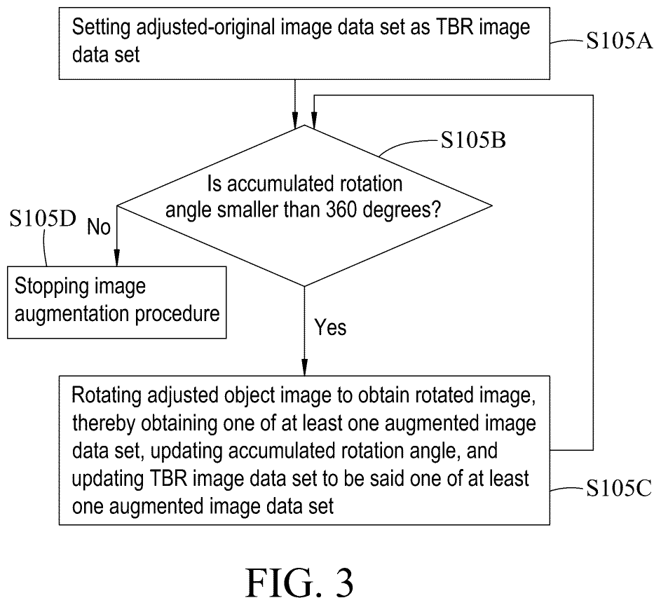

Referring to FIG. 3, in step S105, the processor 13 performs, for each of the adjusted-original image data sets, an image augmentation procedure to obtain the at least one augmented image data set. The image augmentation procedure includes steps S105A to S105D.

In step S105A, the processor 13 sets the adjusted-original image data set as a to-be-rotated (TBR) image data set, which corresponds to one of the accumulated rotation angles that corresponds to one of the original image data sets for which the adjusted-original image data set is obtained.

In step S105B, the processor 13 determines whether said one of the accumulated rotation angles that corresponds to the TBR image data set is smaller than 360 degrees. When the determination is affirmative, the flow goes to step S105C; when the determination is otherwise, the flow goes to step S105D. In step S105D, the processor 13 stops the image augmentation procedure, and the flow goes to step S106.

In step S105C, the processor 13 rotates the adjusted object image that corresponds to the TBR image data set based on the TBR image data set, a predetermined rotation angle, and a predetermined rotation direction to obtain the rotated image, thereby obtaining one of the at least one augmented image data set. The processor 13 then updates said one of the accumulated rotation angles based on the predetermined rotation angle, updates the TBR image data set, which now corresponds to said one of the accumulated rotation angles thus updated, to be said one of the at least one augmented image data set, and repeats step S105B. It should be noted that the predetermined rotation direction is a clockwise direction or an anti-clockwise direction. In this embodiment, the predetermined rotation angle and the predetermined rotation direction may be determined by a user, and the disclosure is not limited in this respect.

For example, in a case where the predetermined rotation angle is 90 degrees and the predetermined rotation direction is clockwise, after the image augmentation procedure, three augmented image data sets may be obtained. The three augmented image data sets correspond to rotated images obtained by rotating the adjusted object image corresponding to the adjusted-original image data set by 90 degrees, 180 degrees, and 270 degrees, respectively. In another case where the predetermined rotation angle is 60 degrees and the predetermined rotation direction is clockwise, after the image augmentation procedure, five augmented image data sets may be obtained. The five augmented image data sets correspond to rotated images obtained by rotating the adjusted object image corresponding to the adjusted-original image data set by 60 degrees, 120 degrees, 180 degrees, 240 degrees, and 300 degrees, respectively.

In step S106, the processor 13 obtains at least one image inspection result based at least on the adjusted-original image data sets that were obtained respectively for the original image data sets. In this embodiment, the at least one image inspection result is obtained for the target object type based on the adjusted-original image data sets that were obtained respectively for those of the original image data sets in the target-TBI data sets, and the at least one augmented image data set obtained for each of the adjusted-original image data sets that correspond to those of the original image data sets in the target-TBI data sets. Then, the processor 13 displays the at least one image inspection result on the display 12.

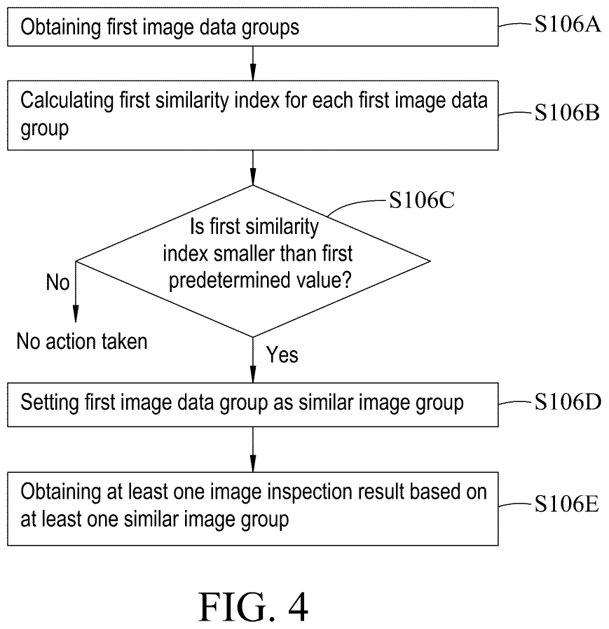

Referring to FIG. 4, in step S106, the processor 13 performs a similar-image identification procedure to identify object images that are similar to each other. The similar-image identification procedure includes steps S106A to S106E.

In step S106A, the processor 13 obtains a plurality of first image data groups based on the adjusted-original image data sets, and the at least one augmented image data set obtained for each of the adjusted-original image data sets. Each of the first image data groups includes two first to-be-analyzed (TBA) image data sets that are different from each other. The two first TBA image data sets correspond respectively to two of the original image data sets that are different from each other, and each of the two first TBA image data sets is one of the adjusted-original image data sets, and the at least one augmented image data set obtained for each of the adjusted-original image data sets.

Take (A) and (B) as adjusted-original image data sets, (A1) as an augmented image data set obtained for (A), and (B1) and (B2) as augmented image data sets obtained for (B) for example, the first image data groups that are obtained include (A, B), (A, B1), (A, B2), (A1, B), (A1, B1), and (A1, B2).

In step S106B, for each of the first image data groups, the processor 13 calculates a first similarity index based on the two first TBA image data sets. In this embodiment, the processor 13 obtains the first similarity index by calculating a mean square error (MSE) based on first-image values respectively of the two first TBA image data sets. Each of the first-image values includes the pixel width number, the pixel height number and an RGB value that correspond to a respective one of the two first TBA image data sets. In this embodiment, a smaller mean square error indicates a higher similarity between the two first TBA image data sets. However, the way of obtaining the first similarity index is not limited to this disclosure.

In step S106C, for each of the first image data groups, the processor 13 determines whether the two first TBA image data sets are similar based on the first similarity index calculated for the first image data group. In this embodiment, the processor 13 determines whether the first similarity index is smaller than a first predetermined value. When the determination is affirmative (i.e., the first similarity index is smaller than the first predetermined value, which means that the two first TBA image data sets are similar), the flow goes to step S106D; when the determination is otherwise, no action is taken.

In step S106D, the processor 13 sets the first image data group as a similar image group.

In step S106E, after at least one similar image group has been obtained for the first image data groups, the processor 13 obtains the at least one image inspection result based on the at least one similar image group.

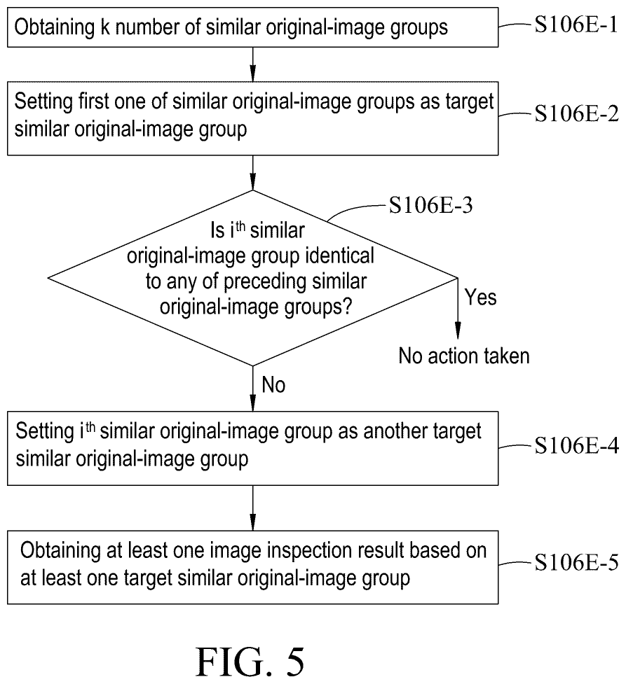

Referring to FIG. 5, in this embodiment, step S106E includes a duplicate elimination procedure to identify duplicates in the at least one similar image group. The duplicate elimination procedure includes steps S106E-1 to S106E-5. In other embodiments, the processor 13 may set the at least one similar image group as the at least one image inspection result without the processor 13 removing the duplicates in the at least one similar image group.

In step S106E-1, in a case where the at least one similar image group includes k number of similar image groups, where k≥2, the processor 13 obtains k number of similar original-image groups based respectively on the k number of similar image groups. Specifically, each of the k number of similar original-image groups includes the two of the original image data sets that correspond respectively to the two first TBA image data sets in the respective one of the k number of similar image groups.

In step S106E-2, the processor 13 sets a first one of the k number of similar original-image groups as one of at least one target similar original-image group.

In step S106E-3, for each positive integer i such that 2≤i≤k, the processor 13 determines whether an i^{th} one of the k number of similar original-image groups (hereinafter referred to as “the i^{th} similar original-image group”) is identical to any one of those of the k number of similar original-image groups before the i^{th} similar original-image group. When the determination is affirmative, no action is taken; when the determination is negative, the flow goes to step S106E-4.

In step S106E-4, the processor 13 sets the i^{th} similar original-image group as another one of the at least one target similar original-image group.

In step S106E-5, the processor 13 obtains the at least one image inspection result based on the at least one target similar original-image group. It should be mentioned that, in other embodiments, the processor 13 further displays two of the additional data sets that correspond respectively to the two of the original image data sets of each of the at least one target similar original-image group on the display 12.

For example, if the at least one similar image group includes (A1, B1) and (A1, B2), and the similar original-image groups obtained based respectively on the (A1, B1) and the (A1, B2) are both (A, B), the processor 13 sets the similar original-image group (A, B) as a target similar original-image group only once, thereby eliminating any duplicate of the similar original-image group (A, B).

By virtue of the abovementioned arrangements, the method for acceptance inspection audit of this disclosure is capable of identifying image duplication in false acceptances or falsified purchase orders, where suppliers or inspection personnel may reuse the same photo as evidence across multiple procurement cases to complete procurement inspection and obtain payment. Since procurement cases and purchase orders may involve large quantity of images during an acceptance inspection audit, the method for acceptance inspection audit of this disclosure, by obtaining the at least one image inspection result, is able to flag potential false acceptances or falsified purchased orders for the user to perform further inspections, thereby significantly reducing audit time needed to go through each acceptance or purchase order.

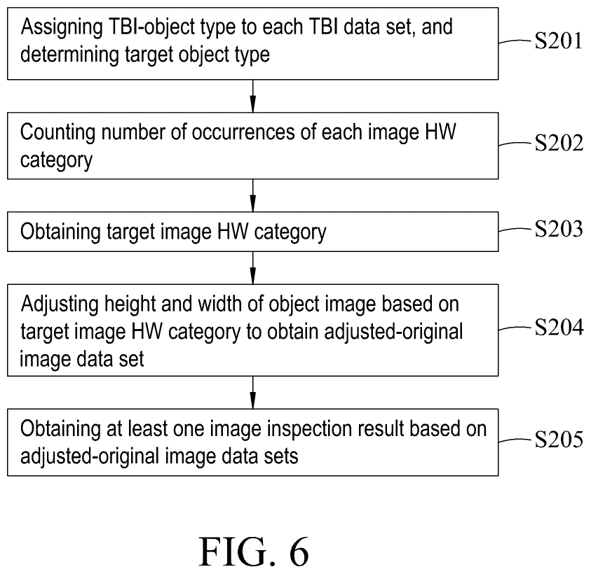

Referring to FIG. 6, the method for acceptance inspection audit according to a second embodiment of the present disclosure is also implemented by the computer 1 in FIG. 1. In the second embodiment, the method includes a non-similar image inspection procedure that includes steps S201 to S205. Steps S201 to S204 of the second embodiment are respectively similar to steps S101 to S104 of the first embodiment.

In step S201, for each of the TBI data sets, the processor 13 assigns a TBI-object type from among a plurality of TBI-object types to the TBI data set. The processor 13 then selects one of the TBI-object types as a target object type. Those of the TBI data sets assigned with the TBI-object type that matches the target object type serves as target-TBI data sets. In this embodiment, the subsequent steps are performed with respect to the target-TBI data sets, and sometimes the term “target-TBI data sets” may be omitted in the following description for the sake of brevity. In other embodiments, step 201 may be omitted where the processor 13 does not classify the TBI data sets, and the subsequent steps may be performed with respect to all of the TBI data sets.

In step S202, the processor 13 counts a number of occurrences of each of the image HW categories based on target-image HW data sets, which are those of the image HW data sets that correspond to those of the original image data sets of the target-TBI data sets.

In step S203, the processor 13 obtains, as a target image HW category, one of the image HW categories that is in the target-image HW data sets, and that has a greatest number of occurrences.

In step S204, for each of the original image data sets in the group of TBI data sets (e.g., the target TBI data sets in the case where step S201 is performed, or the plurality of TBI data sets in the case where step S201 is omitted), the processor 13 obtains the adjusted-original image data set by adjusting the height and the width of the object image that corresponds to the original image data set based on the target image HW category.

In step S205, the processor 13 obtains at least one image inspection result based on the adjusted-original image data sets that were obtained respectively for the original image data sets, and displays the at least one image inspection result on the display 12.

Similar to the first embodiment, by virtue of the abovementioned arrangements, the method for acceptance inspection audit according to the second embodiment is capable of identifying image duplication in false acceptances or falsified purchase orders, where suppliers or inspection personnel may reuse the same photo as evidence across multiple procurement cases to complete procurement inspection and obtain payment. Since procurement cases and purchase orders may involve large quantity of images during acceptance inspection audit, the method for acceptance inspection audit of the second embodiment, by obtaining the at least one image inspection result, is also able to flag potential false acceptances or falsified purchased orders for the user to perform further inspection, thereby significantly reducing audit time needed to go through each acceptance or purchase order.

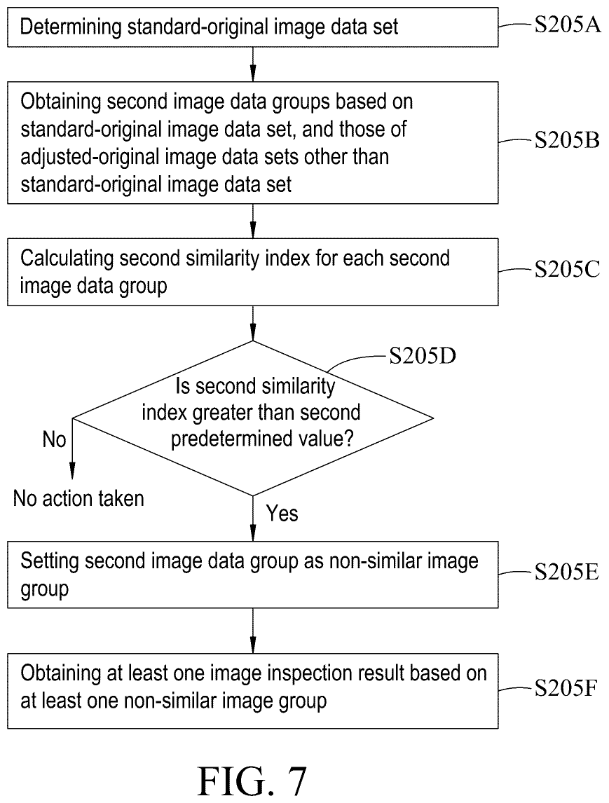

Referring to FIG. 7, in step S205, the processor 13 performs a non-similar image identification procedure to identify object images that are not similar to each other. The non-similar image identification procedure includes steps S205A to S205F.

In step S205A, the processor 13 selects one of the adjusted-original image data sets as a standard-original image data set.

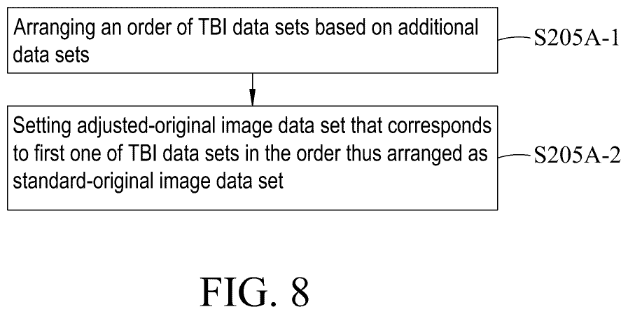

Further referring to FIG. 8, in step S205A, the processor 13 performs a standard-original image selection procedure to select the standard-original image data set. The standard-original image selection procedure includes steps S205A-1 and S205A-2.

In step S205A-1, the processor 13 arranges an order of the target-TBI data sets (or the TBI data sets in the case where step S201 is omitted) based on the additional data sets of the target-TBI data sets.

In step S205A-2, the processor 13 sets the adjusted-original image data set that corresponds to a first one of the target-TBI data sets in the order thus arranged as the standard-original image data set. In other embodiments, the way of the processor 13 setting the standard-original image data set may be based on other conditions and is not limited to this disclosure.

In step S205B, the processor 13 obtains a plurality of second image data groups based on the standard-original image data set, and the adjusted-original image data sets that correspond to those of the original image data sets in the target-TBI data sets other than the standard-original image data set. Each of the second image data groups includes two second TBA image data sets that are different from each other. In the second embodiment, one of the two second TBA image data sets includes the standard-original image data set, and the other one of the two second TBA image data sets includes one of the adjusted-original image data sets other than the standard-original image data set.

In step S205C, for each of the second image data groups, the processor 13 calculates a second similarity index based on the two second TBA image data sets. In the second embodiment, the processor 13 obtains the second similarity index by calculating a mean square error (MSE) based on second-image values respectively of the two second TBA image data sets. Each of the second-image values includes the pixel width number, the pixel height number and the RGB value that correspond to a respective one of the two second TBA image data sets. In the second embodiment, a greater mean square error indicates a higher disparity between the two second TBA image data sets. However, the way of obtaining the second similarity index is not limited to this disclosure.

In step S205D, for each of the second image data groups, the processor 13 determines whether the two second TBA image data sets are similar based on the second similarity index calculated for the second image data group. In this embodiment, the processor 13 determines whether the second similarity index is greater than a second predetermined value. When the determination is affirmative (i.e., the second similarity index is greater than the second predetermined value, which means that the two second TBA image data sets are not similar), the flow goes to step S205E; when the determination is otherwise, no action is taken.

In step S205E, the processor 13 sets the second image data group as a non-similar image group.

In step S205F, after at least one non-similar image group has been obtained for the second image data groups, the processor 13 obtains the at least one image inspection result based on the at least one non-similar image group. It should be mentioned that, in other embodiments, the processor 13 further displays, on the display 12, the additional data set of one of the TBI data sets that includes the original image data set for which the standard-original image data set is obtained, and, for each of the at least one non-similar image group, the additional data set of one of the TBI data sets that includes the original image data sets for which the other one of the two second TBA image data sets is obtained.

In summary, in the first embodiment, by virtue of the abovementioned arrangements, for each of the original image data sets, the processor 13 is able to adjust the height and the width of each of the object images that correspond respectively to the original image data sets in the minimum number of times. The processor 13 then performs the image augmentation procedure to obtain the at least one augmented image data set, and calculates the MSE to obtain the first similarity index for each of the first image data groups, thereby being able to obtain the at least one image inspection result that corresponds to the at least one similar image group or the at least one target similar original-image group having relatively high similarity. In the second embodiment, after the processor 13 has adjusted each of the object images that correspond respectively to the original image data sets, the processor 13 obtains the standard-original image data set used as a comparison standard, and calculates the MSE to obtain the second similarity index for each of the second image data groups, thereby being able to obtain the at least one image inspection result that corresponds to the at least one non-similar image group having relatively high disparity. By virtue of the abovementioned arrangements, the method for acceptance inspection audit of this disclosure is able to effectively assist an auditing process of an acceptance unit, thereby saving time by automating the auditing process and reducing errors in detection of abnormalities due to human error.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for acceptance inspection audit being implemented by a computer, the computer storing a plurality of to-be-inspected (TBI) data sets, each of the plurality of TBI data sets including a respective one of a plurality of original image data sets, each of the plurality of original image data sets corresponding to an object image of a respective one of a plurality of TBI objects, and an image height-width (HW) data set of the object image that corresponds to one of a plurality of image HW categories, said method comprising steps of:
A) based on the image HW data sets that correspond to the plurality of original image data sets, counting a number of occurrences of each of the plurality of image HW categories;
B) obtaining, as a target image HW category, one of the plurality of image HW categories that has a greatest number of occurrences;
C) for each of the plurality of original image data sets in a group of the plurality of TBI data sets, adjusting a height and a width of the object image that corresponds to the original image data set based on the target image HW category, thereby obtaining an adjusted-original image data set that corresponds to an adjusted object image, which is the object image that has been adjusted; and
D) obtaining at least one image inspection result based at least on the adjusted-original image data sets that were obtained respectively for the plurality of original image data sets.

2. The method as claimed in claim 1, further comprising steps of, before step A):
E) assigning a TBI-object type from among a plurality of TBI-object types to each of the plurality of TBI data sets; and
F) selecting one of the plurality of TBI-object types as a target object type, those of the plurality of TBI data sets assigned with the TBI-object type that matches the target object type serving as target-TBI data sets, which form the group of the plurality of TBI data sets,
wherein, in step A), the number of occurrences of each of the plurality of image HW categories is counted based on target-image HW data sets, which are those of the image HW data sets that correspond to those of the plurality of original image data sets of the target-TBI data sets,
wherein, in step B), said one of the plurality of image HW categories that serves as the target image HW category has the greatest number of occurrences in the target-image HW data sets,
wherein, in step C), for each of the plurality of original image data sets in the target-TBI data sets, the adjusted-original image data set is obtained by adjusting the height and the width of the object image that corresponds to the original image data set based on the target image HW category,
wherein, in step D), the at least one image inspection result is obtained for the target object type based at least on the adjusted-original image data sets that were obtained respectively for those of the plurality of original image data sets in the target-TBI data sets.

3. The method as claimed in claim 1, further comprising a step of, in between step C) and step D):
E) for each of the adjusted-original image data sets, obtaining at least one augmented image data set based on the adjusted-original image data set, wherein each of the at least one augmented image data set corresponds to a rotated image that is obtained by rotating the adjusted object image corresponding to the adjusted-original image data set,
wherein, in step D), the at least one image inspection result is obtained based on the adjusted-original image data sets and the at least one augmented image data set obtained for each of the adjusted-original image data sets.

4. The method as claimed in claim 3, the computer further storing a plurality of accumulated rotation angles that correspond respectively to the plurality of original image data sets, each of the plurality of accumulated rotation angles having an initial value of zero, wherein step E) includes performing, for each of the adjusted-original image data sets, an image augmentation procedure to obtain the at least one augmented image data set, the image augmentation procedure including steps of:
E1) setting the adjusted-original image data set as a to-be-rotated (TBR) image data set, which corresponds to one of the plurality of accumulated rotation angles that corresponds to one of the plurality of original image data sets for which the adjusted-original image data set is obtained;
E2) determining whether said one of the plurality of accumulated rotation angles that corresponds to the TBR image data set is smaller than 360 degrees;
E3) in response to determining that said one of the plurality of accumulated rotation angles is smaller than 360 degrees, rotating the adjusted object image that corresponds to the TBR image data set based on the TBR image data set, a predetermined rotation angle, and a predetermined rotation direction to obtain the rotated image, thereby obtaining one of the at least one augmented image data set, step E3) further including updating said one of the plurality of accumulated rotation angles based on the predetermined rotation angle, updating the TBR image data set to be said one of the at least one augmented image data set that corresponds to said one of the plurality of accumulated rotation angles thus updated, and repeating step E2); and
E4) in response to determining that said one of the plurality of accumulated rotation angles is not smaller than 360 degrees, stopping the image augmentation procedure.

5. The method as claimed in claim 3, wherein step D) includes sub-steps of:
D1) obtaining a plurality of image data groups based on the adjusted-original image data sets, and the at least one augmented image data set obtained for each of the adjusted-original image data sets, each of the plurality of image data groups including two to-be-analyzed (TBA) image data sets that are different from each other, the two TBA image data sets corresponding respectively to two of the plurality of original image data sets that are different from each other, and each of the two TBA image data sets being one of the adjusted-original image data sets, and the at least one augmented image data set obtained for each of the adjusted-original image data sets;
D2) for each of the plurality of image data groups, calculating a similarity index based on the two TBA image data sets;
D3) for each of the plurality of image data groups, determining whether the two TBA image data sets are similar based on the similarity index;
D4) for each of the plurality of image data groups, in response to determining that the two TBA image data sets are similar, setting the image data group as a similar image group; and
D5) after at least one similar image group has been obtained for the plurality of image data groups, obtaining the at least one image inspection result based on the at least one similar image group.

6. The method as claimed in claim 5, the at least one similar image group including k number of similar image groups, where k≥2, wherein sub-step D5) includes:
obtaining k number of similar original-image groups based respectively on the k number of similar image groups, each of the k number of similar original-image groups including the two of the plurality of original image data sets that correspond respectively to the two TBA image data sets in the respective one of the k number of similar image groups;
setting a first one of the k number of similar original-image groups as one of at least one target similar original-image group;
for each positive integer i such that 2≤i≤k, determining whether an i^{th} one of the k number of similar original-image groups is identical to any one of those of the k number of similar original-image groups before said i^{th} one of the k number of similar original-image groups;
in response to determining that said i^{th} one of the k number of similar original-image groups is not identical to any one of those of the k number of similar original-image groups before said i^{th} one of the k number of similar original-image groups, setting said i^{th} one of the k number of similar original-image groups as another one of the at least one target similar original-image group; and
obtaining the at least one image inspection result based on the at least one target similar original-image group.

7. The method as claimed in claim 1, wherein step D) further includes sub-steps of:
D1) selecting one of the adjusted-original image data sets as a standard-original image data set;
D2) obtaining a plurality of image data groups, each including two to-be-analyzed (TBA) image data sets that are different from each other, one of the two TBA image data sets including the standard-original image data set, and the other one of the two TBA image data sets including one of the adjusted-original image data sets other than the standard-original image data set;
D3) for each of the plurality of image data groups, calculating a similarity index based on the two TBA image data sets;
D4) for each of the plurality of image data groups, determining whether the two TBA image data sets are similar based on the similarity index;
D5) for each of the plurality of image data groups, in response to determining that the two TBA image data sets are not similar, setting the image data group as a non-similar image group; and
D6) after at least one non-similar image group has been obtained for the plurality of image data groups, obtaining the at least one image inspection result based on the at least one non-similar image group.

8. The method as claimed in claim 7, each of the plurality of TBI data sets further including a respective one of a plurality of additional data sets, the plurality of additional data sets corresponding respectively to the plurality of TBI objects, wherein sub-step D1) includes:
based on the plurality of additional data sets, arranging an order of the plurality of TBI data sets; and
setting the adjusted-original image data set that corresponds to a first one of the plurality of TBI data sets in the order thus arranged as the standard-original image data set.

9. The method as claimed in claim 8, each of the plurality of additional data sets including at least one of a purchaser, a manufacturer code, a manufacturer name, an acceptance date, and an acceptor.
